(19) United States
(12) Patent Application Publication
(10) Pub. No.: US 2008/0091793 A1
(43) Pub. Date: Apr. 17, 2008

(54) METHODS AND APPARATUS TO PROVIDE SERVICE INFORMATION AND ACTIVATE COMMUNICATION SERVICES AT A NETWORK DEMARCATION POINT

(76) Inventors: Yolius Diroo, San Antonio, TX (US); Edward Alan Walter, Boerne, TX (US); Barbara Engel Smith, San Antonio, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/549,777

(22) Filed: Oct. 16, 2006

(51) Int. Cl. G06F 15/16

(52) U.S. Cl. 709/217

(57) ABSTRACT

Methods and apparatus to provide service information and activate communication services at a network demarcation point are disclosed. An example method comprises detecting coupling of a subscriber communication device to a network demarcation unit, and automatically providing service information from the network demarcation unit to a user of the communication device.

### FIELD OF THE DISCLOSURE

This disclosure relates generally to communication services and, more particularly, to methods and apparatus to provide service information and activate communication services at a network demarcation point.

### BACKGROUND

As commonly used in the industry, the term “network demarcation point” denotes a location where cabling and/or equipment associated with a service provider is physically, electrically and/or communicatively coupled to cabling and/or equipment associated with a subscriber, user and/or customer. Such subscriber cabling and/or equipment is often owned by the customer but may, in some instances, be owned, leased and/or otherwise provided by the service provider. Typically a network demarcation unit is located at the network demarcation point to implement the physical, electrical and/or communicative coupling between the subscriber and service provider sides of the network demarcation point. In some examples, a network interface device (NID) contains a first set of screw terminals, jacks and/or jumpers to couple service provider cabling to the network demarcation point, and a second set of screw terminals, jacks and/or jumpers to couple subscriber cabling to the network demarcation point. In such examples, the network demarcation unit couples the two sets of cabling across the network demarcation point. In other examples, a demarcation unit, such as an optical network termination (ONT), contains circuits, modules, devices and/or logic that performs coupling across the network demarcation point. For instance, an ONT can transmit and/or receive an optical signal to and/or from a service provider via a fiber optic cable, and receive and/or transmit one or more signals via one or more cables from and/or to to a subscriber. Other example network demarcation units include multimedia terminal adapters, embedded multimedia terminal adapters, etc.

Today, many buildings, such as homes, apartments, schools, dormitories, and/or places of business (i.e., locations), are pre-wired with standard RJ-11 telephone jacks and/or cabling that are able to couple any number and/or type(s) of telephones to a network demarcation unit, such as an ONT and/or NID mounted on a side of the building. Some example locations are also pre-wired with standard RJ-45 data communication jacks and/or cabling that are able to electrically couple Internet protocol (IP) enabled devices to an already installed ONT. Further still, some example locations are pre-wired with standard F-type connectors and/or coaxial cabling (e.g., RG-59 cabling) that are able to couple cable TV devices to an already installed ONT.

Today, regardless of whether a particular location is pre-wired, a person desiring a communication service is required to contact a communication service provider to request that service. The communication service provider, often at some later point in time, configures and/or enables their communication service network to provision the requested communication service.

### BRIEF DESCRIPTION OF THE DRAWINGS

FIG. 1 is a schematic illustration of an example communication system constructed in accordance with the teachings of the invention.

FIG. 2 illustrates an example manner of implementing the example optical network terminal (ONT) of FIG. 1.

FIG. 3 illustrates an example manner of implementing the example network interface demarcation (NID) of FIG. 1.

FIG. 4 illustrates an example manner of implementing any or all of the example service modules of FIGS. 1, 2 and 3.

FIG. 5 illustrates an example manner of implementing the example voice module of FIG. 4.

FIG. 6 illustrates an example manner of implementing the example web module of FIG. 4.

FIG. 7 illustrates an example data structure to implement the example subscription table of FIG. 4.

FIG. 8 illustrates an example user interface that may be used to implement a subscription selection prompt.

FIGS. 9A and 9B are flowcharts representative of example machine readable instructions which may be executed to implement the example service modules and/or the example voice module of FIGS. 1, 4 and/or 5.

FIG. 10 is a flowchart representative of example machine readable instructions which may be executed to implement the example service modules and/or the example web modules of FIGS. 1, 4 and/or 6.

FIG. 11 is a flowchart representative of example machine readable instructions which may be executed to implement the example telephone switch of FIG. 1.

FIG. 12 is a schematic illustration of an example processor platform that may be used and/or programmed to execute the example machine readable instructions represented by FIGS. 9A, 9B, 10 and/or 11 to implement the example service modules, the example voice modules, the example web modules and/or the example telephone switches described herein.

### DETAILED DESCRIPTION

Methods and apparatus to provide service information and activate communication services at a network demarcation point are disclosed. A disclosed example method comprises detecting coupling of a subscriber communication device to a network demarcation unit, and automatically providing service information from the network demarcation unit to a user of the subscriber communication device. A disclosed example apparatus comprises a service module to detect coupling of a communication device, and to provide service information to a user of the communication device; and a connector to couple the communication device to the service module.

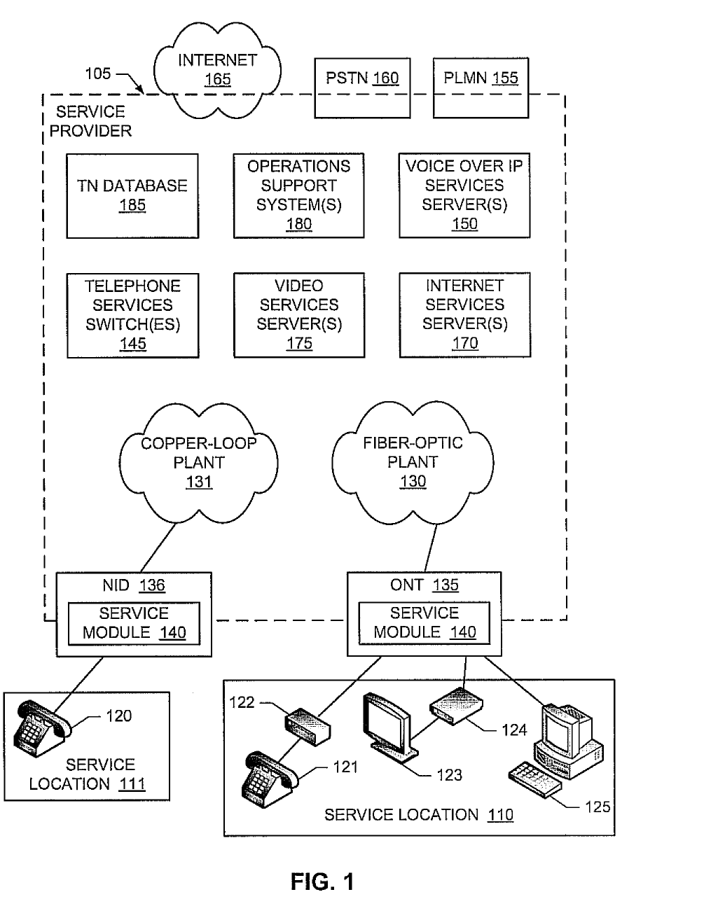

FIG. 1 is a schematic illustration of an example communication system constructed in accordance with the teaching of the invention. In the interest of brevity and clarity, throughout the following disclosure references will be made to advertising and/or activating communication services for the example communication system of FIG. 1. However, it should be understood that the methods and apparatus to advertise and/or activate communication services described herein are applicable to other types and/or varieties of communication services, networks, technologies and/or systems such as public land-mobile network (PLMN) systems, wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, and/or combinations and/or hybrids of these devices, systems and/or networks.

To provide communication services, the example communication system of FIG. 1 includes a service provider 105. The example service provider 105 provides one or more of any types of communication services to any number of subscribers and/or locations of the same or different types. Example communication services include, but are not limited to, plain old telephone service (POTS), Internet access, cable television (TV), Internet Protocol (IP) TV, voice over IP (VoIP) telephone service, messaging service, cellular phone service, electronic mail, etc. In the interest of brevity and clarity, only a single service provider 105 is illustrated in FIG. 1, however, persons of ordinary skill in the art will readily appreciate that the example communication systems can include any number and/or type(s) of service providers 105. Moreover, any subscriber may receive any number of communication services via any number and/or type(s) of service providers.

The example communication system of FIG. 1 may be used to provide communication services to any number and/or type(s) of subscribers located at any number and/or type(s) of locations, two of which are illustrated in FIG. 1 with reference numerals 110 and 111. Example locations include, for example, an apartment 110, a residence 111, a dorm room, a place of business, a restaurant, and/or any other private and/or public location. As described below, each of the example locations 110, 110 may have any number of associated users and/or subscribers and/or any number and/or type(s) of communication services from any number of service providers. While two example locations 110, 111 are illustrated in FIG. 1, persons of ordinary skill in the art will readily appreciate that the example communication system of FIG. 1 could include any number and/or type(s) of subscriber locations.

In the illustrated example of FIG. 1, any number and/or type(s) of subscriber communication devices and/or equipment may be located at and/or within the example subscriber locations 110, 111. Example subscriber devices include, but are not limited to, a telephone 120, a telephone 121 connected to a VoIP analog telephone adapter 122, a TV 123 connected to a set-top box, video cassette recorder and/or digital video recorder 124, a personal computer 125, a TV, a smart phone, a VoIP phone, a residential gateway, a router, a bridge, a digital subscriber line (DSL) modem, a cable modem, a voice-band modem, a wireless access point, a personal digital assistant, a media player, etc. While in subsequent descriptions reference will be made to the example locations 110, 111 and/or the example subscriber communication devices 120-125 illustrated in FIG. 1, persons of ordinary skill in the art will recognize that the methods and apparatus described herein may be applied to any locations and/or subscriber communication devices.

To communicatively couple communication services to subscriber locations (e.g., the example locations 110, 111), the example service provider 105 of FIG. 1 includes one or more distribution facilities, such as an fiber-optic plant 130 and a copper-loop plant 131. Other example distribution facilities include cable TV networks, wireless networks, satellite networks, cellular networks, power-line systems, etc., and/or any combination(s) and/or hybrid(s) of such networks and/or systems. The example fiber optic plant 130 of FIG. 1 includes any type(s), combination(s) and/or topology(-ies) of optical cabling and/or devices that provide communication services, such as POTS, IPTV, cable TV, Internet access, VoIP, etc., to any of a plurality of subscribers spread over any size and/or shape of geographic area and/or region. For example, the fiber optic plant 130 could be implemented as a fiber-to-the-home network, a fiber-to-the-curb network, a fiber-to-the-pedestal network, a fiber-to-the-vault network, a fiber-to-the-neighborhood network and/or any combination(s) thereof. The example copper-loop plant 131 of FIG. 1 includes any type(s), combination(s) and/or topology(-ies) of twisted-pair copper wiring to provide communication services, such as POTS, VoIP, Internet access, etc., to any of a plurality of subscribers spread over any size and/or shape of geographic area and/or region. The example copper-loop plants 131 may be, for instance, any portion of a public switched telephone network (PSTN). Persons of ordinary skill in the art will readily recognize that methods and apparatus to advertise and activate communication services described herein may be utilized for any distribution facilities implemented using any type(s) and/or any combination(s) of cabling, devices and/or topology. Accordingly, the example fiber-optic plant 130 and the example copper-loop plant 131 are merely illustrative examples.

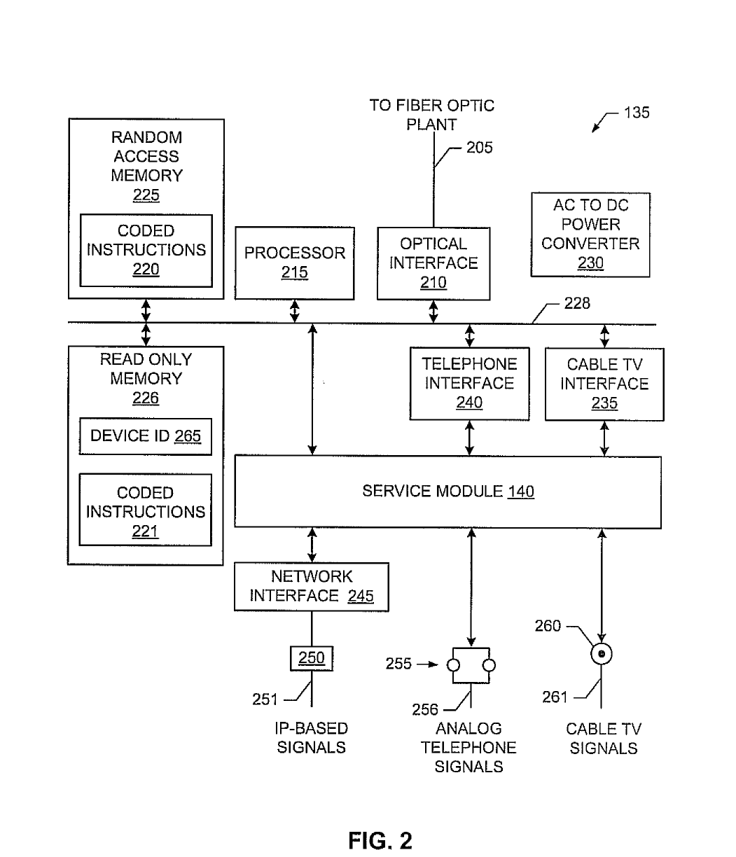

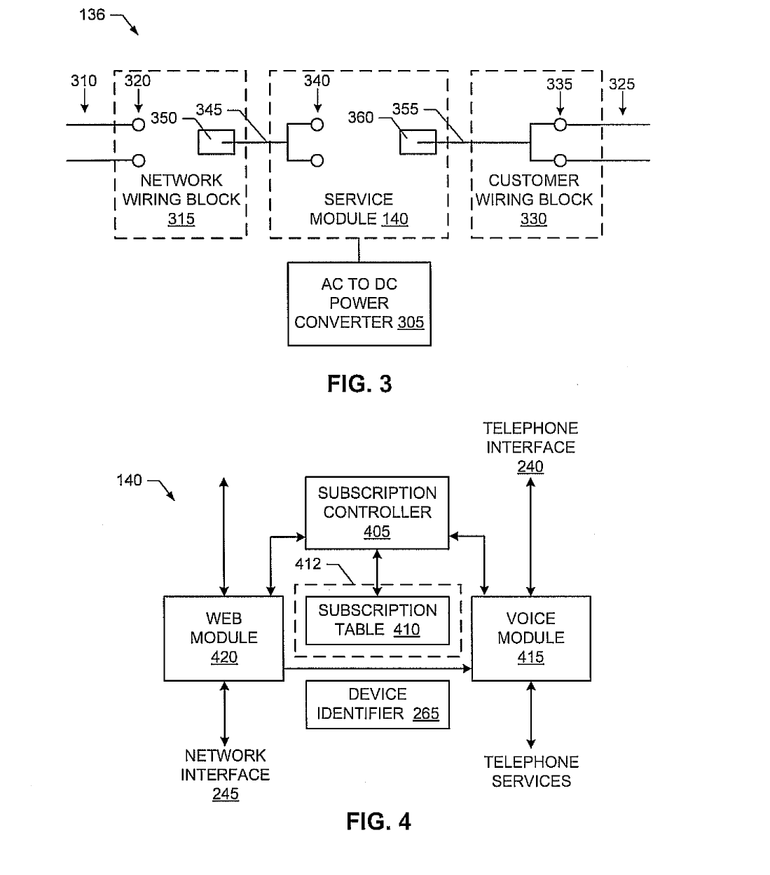

To physically, communicatively and/or electrically couple communication services and/or cabling across network demarcation points, the example communication system of FIG. 1 includes any number of network demarcation units, two of which are illustrated in FIG. 1 with reference numbers 135 and 136. The example network demarcation units 135, 136 of FIG. 1 may be implemented by any type of network demarcation unit(s). Example network demarcation units include, but are not limited to, an ONT 135, a NID 136, a multimedia terminal adapter, an embedded multimedia terminal adapter, etc. Each of the network demarcation units 135, 136 of FIG. 1 provide physical, electric and/or communicative coupling for any type(s) and/or number of cabling, communication services and/or subscribers. Example manners of implementing the example ONT 135 and the example NID 136 are discussed below in connection with FIGS. 2 and 3.

Some example ONTs 135 provide coupling between a single fiber-optic cable and one or more cables and/or cable types to provide one or more communication services to one or more subscribers. For example, an ONT 135 might be located at and/or near a multiple-dwelling and/or apartment building and be used to offer and/or provide POTS, VoIP, Internet access, cable TV and/or IP TV to one or more subscribers residing within the building. In such examples, the subscribers are able to subscribe to different combinations of communication services. Some example NIDs 136 provide coupling for POTS services for up to four telephone numbers for a single residence. Other example NIDs 136 provide coupling for POTS services for one or more subscribers residing at one or more residences (e.g., apartments and/or units of a multiple-dwelling and/or apartment building). Persons of ordinary skill in the art will readily recognize that the methods and apparatus described herein may be employed to advertise and activate communication services for any type(s) and/or number of network demarcation units 135, 136 serving any number of subscribers.

To detect the physical, communicative and/or electrical coupling of subscriber communication devices to the network demarcation units 135, 136, each of the example network demarcation units 135, 136 of FIG. 1 include a service module 140. When the presence of a subscriber communication device is detected, the detecting service module 140 of FIG. 1 provides information regarding available communication services (e.g., cost information, service features, advertisements, etc.) to the detected device. The service module 140 may also provide prompts and/or receive inputs that allow a user of the subscriber communication devices to select one or more communication services to be activated. In some examples, the service information, advertisements, prompts and/or the ability received responses are implemented via any number and/or type(s) of user interfaces, such as an interactive voice response system, and/or a web page displayed on a display device, such as a television and/or a display associated with any one or more of a personal computer, a set-top box, a digital video recorder, a VoIP phone, a smart phone, a cell phone, a personal digital assistant, etc. An example manner of implementing either or both of the service modules 140 is discussed below in connection with FIG. 4.

While the example network demarcation units 135, 136 of FIG. 1 include service modules 140 that implement similar functionality and/or contain similar devices, circuits and/or logic, a particular service module 140 implemented by any of the network demarcation units 135, 136 may differ in any of a variety of ways from a service module 140 implemented by any of the other network demarcation units 135, 136. In some examples, a service module 140 implemented for a NID 136 may include only a portion of the devices, circuits and/or logic implemented by a service module 140 utilized in an ONT 135. For example, a first example service module 140 (e.g., implemented by the example ONT 135) supports IP-based communication services, while a second example service module 140 (e.g., implemented by the example NID 136) does not support IP-based services. Moreover, the example service modules 140 may differ in the number and/or type(s) of features they include and/or perform. However, persons of ordinary skill in the art will readily appreciate that, a same type of service module 140 could be used in both the example ONT 135 and the example NID 136 even though, in some examples, only a portion of the functionality of the service module 140 is active, utilized and/or enabled when employed in the NID 136.

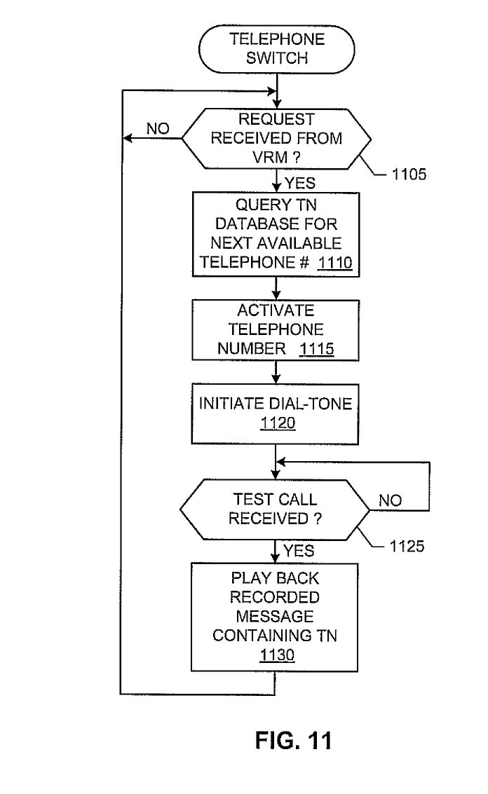

To initiate, receive, establish, complete and/or route any number and/or type(s) of telephone communication services, the example service provider 105 of FIG. 1 may implement, employ, communicate with, and/or contain any portion of any number and/or type(s) of telecommunication switches 145 (e.g., CLASS 5 switches) and/or VoIP services servers 150 (e.g., VoIP call processor(s) and/or VoIP gateway(s)). As illustrated in FIG. 1, the service provider 105 may also include an interface to and/or contain a portion of a PLMN 155, an interface to and/or contain a portion of a PSTN 160, and/or an interface to and/or contain a portion of any number and/or type(s) of additional communication networks, such as the Internet 165. For example, using any number and/or type(s) of technique(s), method(s), protocol(s) and/or technology(-ies), the example CLASS 5 switch 145, the example VoIP services server 150 and/or the example PSTN 160 of FIG. 1 can facilitate telephone calls between the VoIP adapter 122 and a PSTN-based phone. Example machine accessible instructions that may be executed by the example telephone switches 145 to activate telephone services is described in connection with FIG. 11.

The example PLMN 155 and/or the example PSTN 160 of FIG. 1 may be implemented by any number and/or type(s) of communication device(s), switch(es), protocol(s), system(s) and/or technology(-ies). For instance, the example PLMN 155 may include one or more cellular base stations that can transmit cellular signals to and/or receive cellular signals from a cellular communication device (not shown) using any protocols (e.g., time-divisional multiple access (TDMA), code-divisional multiple access (CDMA), orthogonal frequency-division multiplexing (OFDM), etc.).

Persons of ordinary skill in the art will readily appreciate that the example service provider 105, the example PLMN 155, the example PSTN 160, and/or the Internet 165 may be owned and/or operated by any number of operators and/or service providers. In some examples, the service provider 105 operates a PLMN 155, a portion of the PSTN 140 and a portion of the Internet 165. In some other examples, a second service provider operates the PLMN 155, a portion of the PSTN 140 and/or a portion of the Internet 165.

To provide Internet-based services, the example service provider 105 of FIG. 1 includes any number and/or type(s) of Internet services server(s) 170. The example Internet services servers 170 of FIG. 1 provide and/or facilitate one or more Internet-based services, such as Internet access, web browsing, file sharing, electronic mail, text messaging, instant messaging, file transfer, etc. Example Internet services server(s) 170 include, but are not limited to, a DSL access multiplexer (DSLAM), a cable modem headend, a broadband remote access server (BRAS), a web server, a domain name system (DNS) server, and/or a domain host control protocol (DHCP) server.

To provide video services, the example service provider 105 of FIG. 1 includes any number and/or type(s) of video services server(s) 175. The example video services server(s) 175 of FIG. 1 provide and/or serve any number and/or type(s) of on-demand and/or broadcast video and/or television services. Example video services server(s) 175 include, but are not limited to, an analog cable television broadcast system, a digital cable television broadcast system, an IP TV server, and/or a video download server.

To manage communication services, the example service provider 105 of FIG. 1 includes any number and/or type(s) of operations support system(s) 180. The example operations support system(s) 180 of FIG. 1 allow, for example, a technician and/or customer service representative to create subscriber accounts, configure and/or provision communication services, and/or manage existing communication services. In the illustrated example of FIG. 1, the example service modules 140 may also, directly and/or indirectly, interact with the operations support system(s) 180, the telephone switch(-es) 145, the VoIP server(s) 150, the Internet server(s) 170 and/or the video server(s) 175 to create subscriber accounts, configure and/or provision communication services, and/or manage existing accounts and/or communication services. Example operations support system(s) 180 include, but are not limited to, a business support system, an order entry system, and/or a billing system.

To manage telephone numbers for telephone services, the example service provider 105 of FIG. 1 includes a telephone number (TN) database 185. The example TN database 185 of FIG. 1 contains a listing of currently assigned and/or available telephone numbers. For a currently assigned telephone number, the telephone number database 185 of FIG. 1 includes one or more parameters that identify, for example, a particular network demarcation unit 135, 136 associated with the telephone number, a particular port on a telephone switch 145, an IP address associated with a VoIP device, etc.

In the illustrated example of FIG. 1, the example subscriber devices 121-125 may be coupled by and/or through the example network demarcation units 135, 136 and/or the distribution facilities 130, 131 to any of the example servers, systems and/or switches 145, 150, 170, 175, 180 via any past, current and/or future communication network(s), communication system(s), communication device(s), transmission medium(s), protocol(s), technique(s) and/or standard(s). For example, the devices 121-125 may be coupled via any type(s) of twisted-pair cabling, coaxial cabling, data communications cabling (e.g., Category 5 cabling), voice-band modem(s), digital subscriber line (DSL) modem(s), cable modem(s), Ethernet transceiver(s), optical transceiver(s), virtual private network (VPN) connection(s), Institute of Electrical and Electronics Engineers (IEEE) 802.11x (a.k.a. WiFi) transceiver(s), IEEE 802.16 (a.k.a. WiMax), access point(s), access provider network(s), etc.

While an example communication system has been illustrated in FIG. 1, the example distribution facilities 130, 131, the example network demarcation units 135, 136, the example servers, systems and switches 145, 150, 170, 175, 180, and/or the example communication networks 155, 160, 165 illustrated in FIG. 1 may be combined, re-arranged, divided, eliminated and/or implemented in any of a variety of ways. Further, any or all of the example network demarcation units 135, 136, the example service modules 140, and/or the example servers, systems and switches 145, 150, 170, 175, 180 of FIG. 1 may be implemented by hardware, software, firmware and/or any combination of hardware, software and/or firmware. Moreover, the example communication system and/or the example service provider 105 of FIG. 1 may include additional servers, systems, switches, distribution facilities, network demarcation points, network demarcation units, service modules, communication networks and/or interfaces to communication networks than those illustrated in FIG. 1 and/or may include more than one of any or all of the illustrated elements.

FIG. 2 illustrates an example manner of implementing the example ONT 135 of FIG. 1. To transmit and/or receive communication service signals via an optical cable 205, the example ONT 135 of FIG. 2 includes any number and/or type(s) of optical interfaces 210. Using any number and/or type(s) of method(s), circuit(s), logic and/or device(s), the example optical interface 210 of FIG. 2 converts between optical communication services signals of the optical cable 205 and electrical signals suitable for use by other parts of the example ONT 135.

To control overall operation of the example ONT 135 of FIG. 2, the ONT 135 includes any number and/or type(s) of specialized and/or general-purpose processor(s), controller(s) and/or processing unit(s) 215. The example processor 215 of FIG. 2 performs any number and/or type(s) of control, configuring and/or monitoring functions by carrying out and/or executing coded instructions 220 and/or 221 present in a main memory of the processor 215 (e.g., within a random-access memory (RAM) 225 and/or a read-only memory (ROM) 226).

The example processor 215 is in communication with the main memory (including the RAM 225 and/or the ROM 226) and other devices and/or modules of the example ONT 135 of FIG. 2 via any type and/or number of buses 228. The example RAM 225 may be implemented by, for example, dynamic random-access memory (DRAM), synchronous dynamic random-access memory (SDRAM), and/or any other type of RAM device(s), and the example ROM 226 may be implemented by, for example, hard disk drive(s), flash memory(-ies) and/or any other desired type of memory device(s). Access to the example memory 225 and 226 is typically controlled by a memory controller (not shown).

To provide power for the example ONT 135 of FIG. 2, the ONT 135 includes any number and/or type(s) of alternating current (AC) to direct current (DC) power converters 230. The example AC to DC power convert 230 of FIG. 2 is connected to an AC power source via any connector (not shown) and provides DC power for use by other portions of the example ONT 135. Additionally or alternatively, the ONT 135 may include a connector to receive DC power directly from an external power source (not shown), and/or the power converter 230 may obtain and/or receive power via the optical cable 205 and/or any other distribution facility cable (e.g., a line powered ONT 135).

To provide cable TV services, the example ONT 135 of FIG. 2 includes any number and/or type(s) of cable TV interfaces 235. The example cable TV interface 235 of FIG. 2 forms and/or creates one or more analog and/or digital audio and/or video signals from programming guide, TV and/or video data and/or information received via the optical cable 205. Such audio and/or video signals can be received and/or displayed by, for example, a TV, a set-top box, a digital video recorder, a video cassette recorder, a PC, etc.

To provide telephone services, the example ONT 135 of FIG. 2 includes any number and/or type(s) of telephone interfaces 240. An example telephone interface 240 includes any number and/or type(s) of subscriber line interface circuits (SLICs), filter(s), analog-to-digital converter(s) and/or digital-to-analog converter(s) to convert between analog signals sent to and/or received from a telephone (not shown) and digital telephone signals sent to and/or received via the optical cable 205.

VoIP telephone services may also be provided by the example ONT 135 of FIG. 2. For example, VoIP telephone signals may be provided as IP data and/or packets to a coupled VoIP device (not shown) via a network interface 245. Additionally or alternatively, VoIP telephone signals may be received via the optical cable 205 and be converted to analog telephone signals by, for example, the example processor 215 and/or the telephone interface 240. In such examples, VoIP telephone signals and/or protocols are used to implement telephone services between the service provider and the ONT 135, and analog telephone signals are used to provide the telephone service to the subscriber's equipment (i.e., a POTS phone) (not shown). Of course, the example ONT 135 could be used to provide any combination(s) of VoIP telephone signals and/or analog telephone signals to any combination of devices and/or telephones for any combination of subscribers.

To provide IP-based communication services, the example ONT 135 of FIG. 2 includes any number and/or type(s) of network interfaces 245. The example network interface 245 of FIG. 2 implements any number and/or type(s) of communication and/or data interface(s) in accordance with any past, current and/or future standards and/or specifications such as wired and/or wireless Ethernet, DSL, WiMax, WiFi, cable modems, etc.

To detect the physical, electrical and/or communicative coupling of subscriber communication devices to the example ONT 135 of FIG. 2, the ONT 135 includes at least one service module 140. When a subscriber communication device is detected, the example service module 140 of FIG. 2 provides information regarding available communication services (e.g., advertisements), and provides prompts and/or receive inputs that allow a user of the subscriber communication devices to select one or more communication services to be activated. In some examples, the prompts and/or responses are facilitated by an interactive voice response system implemented by the service module 140. In some other examples, the service module 140 implements the prompts and/or responses via any number and/or type(s) of user interfaces, such as a web page, displayed on a display device, such as a television and/or a display associated with any one of a personal computer, a set-top box, a digital video recorder, a VoIP phone, a smart phone, a cell phone, a personal digital assistant, etc. coupled to the example network interface 245 and/or the example cable TV interface 235. An example manner of implementing the service module 140 is discussed below in connection with FIG. 4.

To physically couple subscriber cabling to the example ONT 135 of FIG. 2, the ONT 135 includes any number and/or type(s) of jacks and/or terminals. For example, an RJ-45 jack 250 may be implemented to facilitate the coupling of Category 5 cabling 251 to the ONT 135 for IP-based signals and/or services, a pair of screw terminals 255 may be implemented to facilitate the coupling of twisted-pair telephone cabling 256 to the ONT 135 for analog telephone signals and/or services, an F-connector 260 may be implemented to facilitate the coupling of coaxial cabling 261 to the ONT 135 for radio-frequency (RF) video signals and/or services, etc.

To identify the example ONT 135 of FIG. 2, the ONT 135 includes a device identifier 265. The example device identifier 265 of FIG. 2 uniquely identifies the ONT 135 and is, for example, a manufacturing serial number, a media access control (MAC) address, etc. The example device identifier 265 of FIG. 2 is stored in any number and/or type(s) of non-volatile storage such as the ROM 226. The example processor 215 and/or the service module 140 can read and/or obtain the device identifier 265 from the ROM 226 via the bus 228. Additionally or alternatively, the device identifier 265 may be stored and/or contained within the service module 140 as described in connection with FIG. 2.

While an example ONT 135 is illustrated in FIG. 2, the ONT 135 may be implemented using any number and/or type(s) of other and/or additional processors, devices, components, circuits, modules, interfaces, etc. Further, the processors, devices, components, circuits, modules, elements, interfaces, etc. illustrated in FIG. 2 may be combined, re-arranged, eliminated and/or implemented in any of a variety of ways. For example, as described below in connection with FIG. 3, the service module 140 may be implemented as a separate, insertable and/or replaceable module and, thus, may be coupled in between a customer wiring block portion of the ONT 136 and the remainder of the ONT 136. Additionally, the example optical interface 210, the example processor 215, the example cable TV interface 235, the example telephone interface 240, the example network interface 245, and/or the example service module 140 may be implemented as any combination of firmware, software, logic and/or hardware. Moreover, the example ONT 135 may include additional processors, devices, components, circuits, interfaces and/or modules than those illustrated in FIG. 2 and/or may include more than one of any or all of the illustrated processors, devices, components, circuits, interfaces and/or modules. For example, an ONT 135 may contain any number of telephone interfaces 240, service modules 140, network interfaces 245, cable TV interfaces 235, and/or jacks and/or terminals 250, 255, 260 to provide any number and/or type(s) of communication services to any number of subscribers.

FIG. 3 illustrates an example manner of implementing the example NID 136 of FIG. 1. To provide power for the example NID 136 of FIG. 3, the NID 136 includes any number and/or type(s) of alternating current (AC) to direct current (DC) power converters 305. The example AC to DC power converter 305 of FIG. 3 is connected to an AC power source via any connector (not shown) and provides DC power for use by other portions of the example NID 136 (e.g., the service module 140). Additionally or alternatively, the NID 136 may include any number and/or type(s) of connector(s) to receive DC power directly from an external power source (not shown), and/or the power converter 305 may obtain and/or receive power via a distribution facility cable (e.g., a copper twisted-pair cable 310).

To physically couple distribution facility cabling 310 to the example NID 136 of FIG. 3, the NID 136 includes any number and/or type(s) of network wiring block(s) 315. The example network wiring block 315 of FIG. 3 includes any pair of screw terminals 320 to couple the distribution facilities' copper twisted-pair cabling 310 to the network wiring block 315. Although, for ease of illustration they are not shown, the example network wiring block 315 includes a pair of screw terminals 320 for each service provider twisted-pair 310 supported by the NID 136.

Likewise, to physically couple subscriber cabling 325 to the example NID 136 of FIG. 3, the NID 136 includes any number and/or type(s) of customer wiring blocks 330. The example customer wiring block 330 of FIG. 3 includes a pair of screw terminals 335 to couple the subscriber's copper twisted-pair cabling 325 to the customer wiring block 330. Although, for ease of illustration they are not shown, the example customer wiring block 330 includes a pair of screw terminals 335 for each subscriber twisted-pair 325 supported by the NID 136.

To detect the electrical and/or communicative coupling of one or more subscriber communication devices to the example NID 136 of FIG. 3, the NID 136 includes at least one service module 140. When a subscriber communication device is detected, the example service module 140 of FIG. 3 provides information regarding available communication services (e.g., service availability, service costs, service information, advertisements, etc.) to the detected device, and provides prompts and/or receives inputs that allow a user of the detected subscriber communication device to select one or more communication services to be activated. For example, the prompts and/or responses can be implemented by an interactive voice response system of the example service module 140. An example manner of implementing the service module 140 is discussed below in connection with FIG. 4.

In the illustrated example of FIG. 3, the service module 140 is interposed between the network wiring block 315 and the customer wiring block 330. As such, the service module 140 can interact with a service provider (e.g., the example service provider 105 of FIG. 1) and/or a user of a telephone (e.g., the example telephone 120 of FIG. 1), and can control and/or enable the physical, communicative and/or electrical coupling of the subscriber cabling 325 to the network cabling 310 to enable and/or disable telephone services to the subscriber cabling 325.

The example service module 140 of FIG. 3 is coupled to the network wiring block 315 via a pair of screw terminals 340, a jumper and/or cable 345 and a jack 350. Likewise, the service module 140 is coupled to the customer wiring block 330 via the pair of screw terminals 335, a jumper and/or cable 355 and a jack 360. Persons of ordinary skill in the art will readily appreciate that other methods of coupling the service provider cabling 310 to the network wiring block 315, subscriber cabling 325 to the customer wiring block 330, the service module 140 to the network wiring block 315, and/or the service module 140 to the customer wiring block 330 may be employed.

While a single service module 140 is illustrated in FIG. 3, more than one service module 140 may be implemented within a NID 136. For example, one service module 140 may be implemented for each service provider twisted-pair supported by the NID 136. Additionally or alternatively, the service module 140 may be capable of supporting more than one telephone service and/or service location and, therefore, be coupled to multiple sets of twisted-pairs.

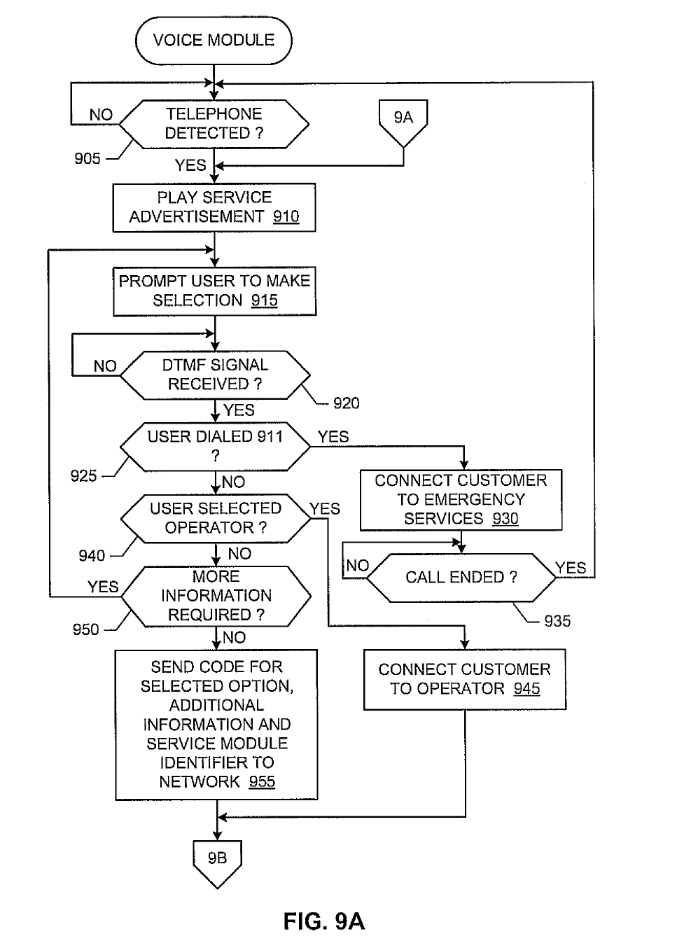

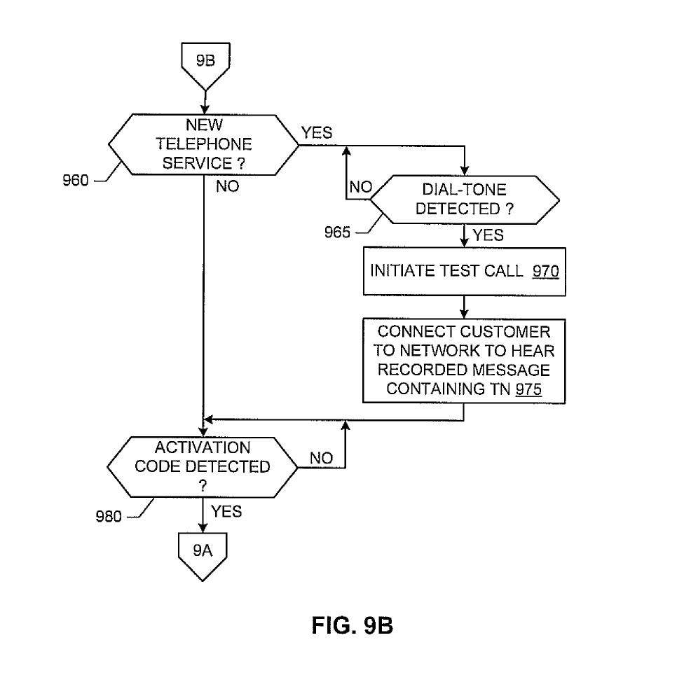

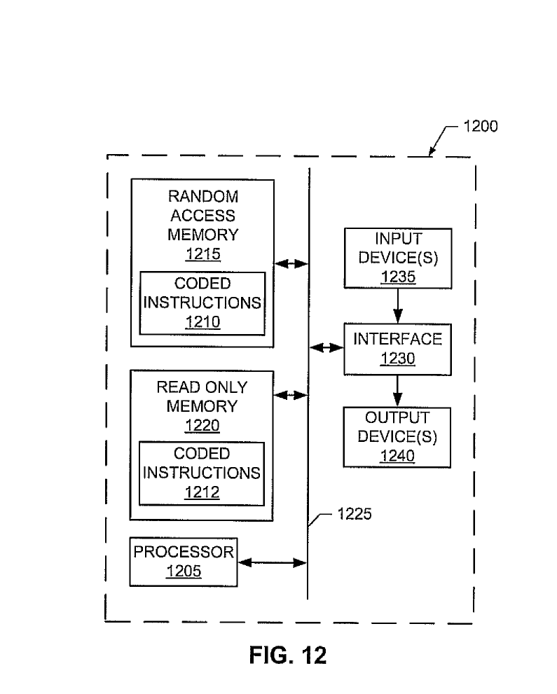

FIG. 4 illustrates an example manner of implementing any or all of the example service modules 140 of FIGS. 1, 2 and/or 3. To control overall operation of the example service module 140 of FIG. 4, the service module 140 includes a subscription controller 405. The example subscription controller 405 of FIG. 4 processes information related to detection of subscriber equipment, provides service selection prompts, receives user selections, and/or makes and/or performs communication service activations. In some examples, the subscription controller 405 is implemented by any number and/or type(s) of processor(s), controller(s) and/or processing unit(s) capable of executing coded instructions (e.g., the example processor 1205 of FIG. 12). For example, the subscription controller 405 could execute any or all of the example machine accessible instructions of FIGS. 9A, 9B and/or 10. In other examples, the subscription controller 405 may be implemented using any number and/or type(s) of application specific integrated circuit(s) (ASIC(s)), programmable logic device(s) (PLD(s)), field programmable logic device(s) (FPLD(s)), discrete logic, hardware, firmware, etc. Moreover, the subscription controller 405 may be implemented manually and/or as any combination(s) of the foregoing techniques.

To identify the example service module 140 of FIG. 4 and/or a network demarcation unit that includes and/or implements the service module 140, the service module 140 optionally includes the device identifier 265. Additionally or alternatively, the device identifier 265 may be stored and/or contained within network demarcation unit 135, 136 as described above in connection with FIG. 2. The example device identifier 265 of FIG. 4 uniquely identifies the example service module 140 and/or a network demarcation unit that includes and/or implements the service module 140 and is, for example, a manufacturing serial number, a MAC address, etc. The example device identifier 265 of FIG. 4 is stored in any number and/or type(s) of non-volatile storage.

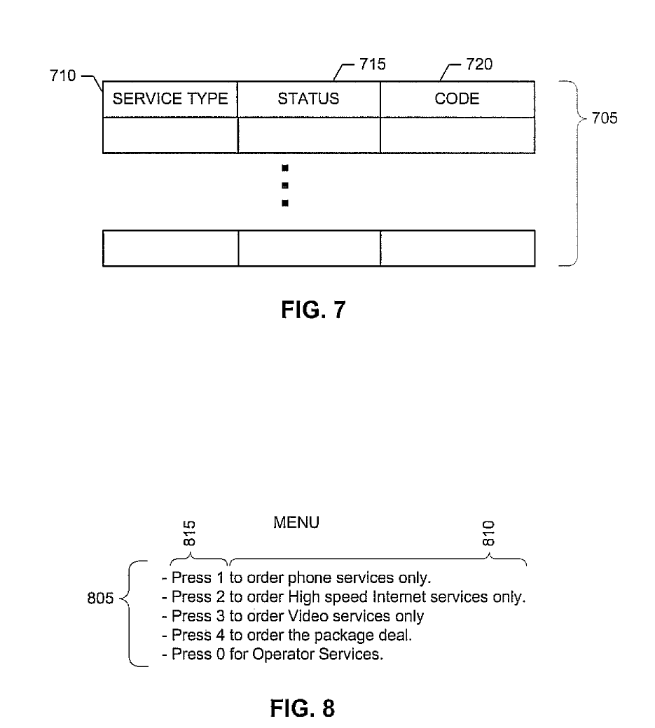

To track and/or record which of one or more communication services are current activated and/or enabled, the example service module 140 of FIG. 4 includes a subscription table 410. For each of a list of potential communication services, the example subscription table 410 includes a status that indicates whether or not the associated communication service is activated and/or enabled. The example subscription controller 405 of FIG. 4 uses the subscription table to determine what if any communication services should be advertised to a subscriber and/or to customize and/or tailor a service selection prompt provided to the subscriber. The example subscription table 410 is stored in any number and/or type(s) of storage device(s) and/or memory(-ies) 412. An example data structure that may be used to implement the subscription table 410 is described in connection with FIG. 7.

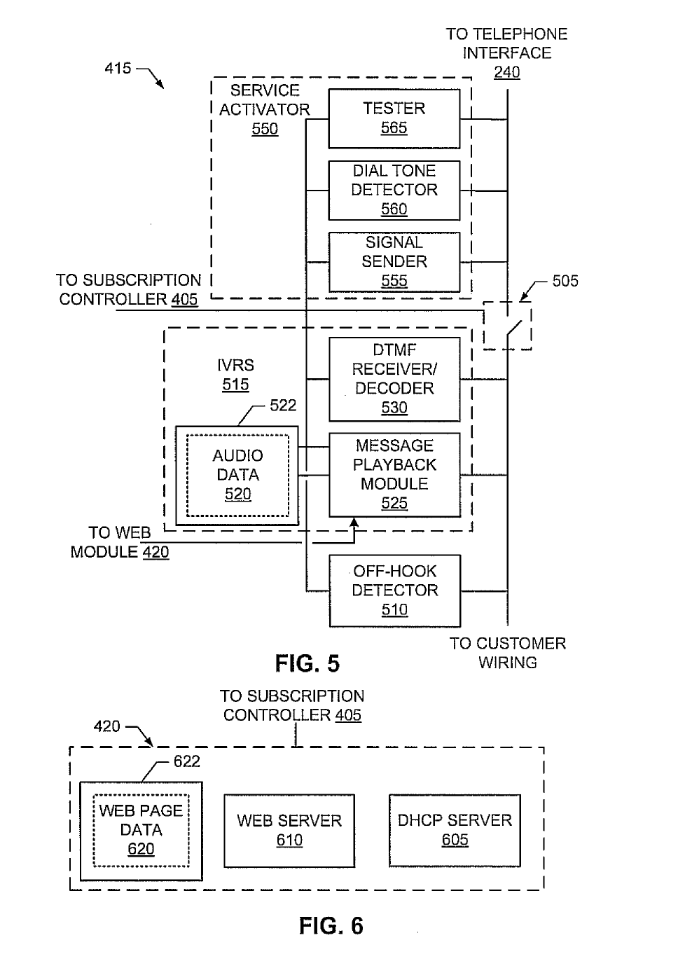

To detect the physical, electrical and/or communicative coupling of a subscriber communication device, such as a telephone, to the service module 140 and/or a network demarcation unit that includes and/or implements the service module 140, the example service module 140 of FIG. 4 includes a voice module 415. The example voice module 415 of FIG. 4 detects the coupling of the telephone by detecting an off-hook state of the telephone. The voice module 415 also implements an interactive voice response system to provide audible prompts and to receive user responses and/or service selections. The example voice module 415 further implements an interface to a telephone switch (e.g., the example telephone switch 145 of FIG. 1) to activate analog telephone services. An example manner of implementing the voice module 415 is described below in connection with FIG. 5.

To detect the physical, electrical and/or communicative coupling of an IP-based and/or enabled subscriber communication device, such as a PC, to the service module 140 and/or a network demarcation unit that includes and/or implements the service module 140, the example service module 140 of FIG. 4 includes a web module 420. The example web module 420 of FIG. 4 detects the coupling of an IP-based device by receiving a DHCP request from the IP-based device. The web module 420 of FIG. 4 also implements a user interface to provide service selection prompts and/or to receive user service selections. An example user interface is discussed below in connection with FIG. 8. The example web module 420 further implements an interface and/or protocol to one or more communication service servers (e.g., the example servers 150, 170, 175, etc.) to enable and/or activate IP-based communication services (e.g., VoIP, cable TV, IP TV, Internet access, etc.). An example manner of implementing the web module 420 is described below in connection with FIG. 6.

If a user selects and/or enters a request to activate an analog telephone service via the example web module 420 of FIG. 4, the web module 420 can, as described in connection with FIG. 5 and as illustrated in FIG. 4, direct the voice module 415 to activate the telephone service for the subscriber. Additionally or alternatively, the web module 420 can interact with a telephone switch (e.g., the example telephone switch 145 of FIG. 1) to activate analog telephone services.

While an example service module 140 is illustrated in FIG. 4, the service module 140 may be implemented using any number and/or type(s) of other and/or additional processors, devices, components, circuits, modules, interfaces, etc. Further, the processors, devices, components, circuits, modules, elements, interfaces, etc. illustrated in FIG. 4 may be combined, re-arranged, eliminated and/or implemented in any of a variety of ways. For example, a service module 140 implemented by a NID 135 may not include the web module 420 when IP-based services are not provided via the NID 135. Additionally, the example controller 405, the example subscription table 410, the example voice module 415, the example web module 420, and/or, more generally, the example service module 140 may be implemented as any combination of firmware, software, logic and/or hardware. Moreover, the example service module 140 may include additional processors, devices, components, circuits, interfaces and/or modules than those illustrated in FIG. 4 and/or may include more than one of any or all of the illustrated processors, devices, components, circuits, interfaces and/or modules.

FIG. 5 illustrates an example manner of implementing the example voice module 415 of FIG. 4. To control the physical, electrical and/or communicative coupling of subscriber cabling to service provider cabling, the example voice module 415 of FIG. 5 includes any number and/or type(s) of switch(es) 505. As illustrated in FIG. 5, the example switch 505 allows the example voice module 415 to interact with a subscriber separately from a service provider, and to restrict access to un-activated telephone services by the subscriber. Under the control of a subscription controller (e.g., the example controller 405 of FIG. 4), the example switch 505 of FIG. 5 connects and/or disconnects both wires of a twisted-pair in tandem. Persons of ordinary skill in the art will readily appreciate that any number and/or type(s) of topologies and/or switches may be used within and/or implemented by a voice module 415.

To detect a coupled telephone, the example voice module 415 of FIG. 5 includes an off-hook detector 510. The example off-hook detector 510 of FIG. 5 detects a coupled telephone by detecting the current that flows through the subscriber cabling due to a low impedance state of the telephone when off-hook (e.g., when a user of the telephone picks up the handset of the telephone). Any number and/or type(s) of other method(s) and/or circuit(s) can, additionally or alternatively, be used to detect the presence of a coupled telephone. Upon detection of an off-hook telephone, the example off-hook detector 510 of FIG. 5 provides an indication of the same to a subscription controller (e.g., the example controller 405 of FIG. 4).

To provide service selection prompts and/or to receive user selections, the example voice module 415 of FIG. 5 includes an interactive voice response system (IVRS) 515. The example interactive voice response system 515 of FIG. 5 is able to provide and/or play all or any portion of audio data 520 that can be listened to by a user of a coupled and off-hook telephone, and/or to receive user selections by detecting dual-tone multiple-frequency (DTMF) signals. The example audio data 520 of FIG. 5 may be stored using any number and/or type(s) of digital audio storage formats, files and/or data structures, such as WAVE files, MP3 files, Windows Media Audio (WMA) files, etc., on any number and/or type(s) of storage devices and/or memories 522. In some examples, the audio data 520 is able to be modified, updated and/or changed by the subscription controller.

To playback the audio data 520, the example interactive voice response system 515 of FIG. 5 includes a message playback module 525. Under the control of a subscription controller (e.g., the example controller 405 of FIG. 4) and/or a web module (e.g., the example web module 420 of FIGS. 4 and/or 6), the example message playback module 525 of FIG. 5 is able to play one or more portions of the audio data 520 in any sequence and/or order. Using any number and/or type(s) of method(s), circuit(s) and/or device(s), the example message playback module 525 converts digital audio data 520 into an analog form and/or analog signal suitable for listening to via a coupled and off-hook telephone.

To receive user selections, the example interactive voice response system 515 of FIG. 5 includes a DTMF receiver and decoder 530. Using any number and/or type(s) of method(s), circuit(s) and/or device(s), the example DTMF receiver and decoder 530 of FIG. 5 detects and/or receives DTMF signals from a coupled and off-hook telephone, and decodes the received signals to determine which of one or more keys of the telephone were pressed by a user of the telephone. The decoded key presses are provided to a subscription controller (e.g., the example controller 405 of FIG. 4), as a portion of a user response and/or communication service selection. Additionally or alternatively, the DTMF receiver and decoder 530 can receive spoken user responses that correspond to one or more keys of the telephone and/or corresponding to phrases, words, letters and/or numbers.

In some examples, the message playback module 525 plays and/or provides one or more portions of the audio data 520 to the user as service selection prompts. In such examples, the portions of the audio data 520 represent portions of service information, advertisements and/or prompts that convey information and/or solicit a response from the user. In other examples, portions of the audio data 520 represent one or more DTMF signals that may be received by the DTMF receiver and decoder 530. In such examples, a web module (e.g., the example web module 420 of FIGS. 4 and/or 6) may direct the message and playback module 525 to play the one or more DTMF signals to mimic user responses and/or service selections. In this way, the web module can utilize the example voice module 415 and/or, more particularly, the example interactive voice response system 515 to activate telephone services.

To activate telephone services, the example voice module 415 of FIG. 4 includes a telephone service activator 550. The example telephone service activator 550 of FIG. 5 communicates with a telephone switch (e.g., the example CLASS 5 switch 145 of FIG. 1) to activate telephone services. In general, the example telephone service activator 550 sends a request to activate a telephone service to the telephone switch, detects that the service has been activated by detecting a dial-tone signal provided by the telephone switch, and then initiates a test call that allows a subscriber to obtain the telephone number assigned to the newly activated telephone service.

To send service activation information to a telephone switch, the example service activator 550 of FIG. 5 includes a signal sender 555. The example signal sender 555 of FIG. 5 sends the service activation information using any number and/or type(s) of technique(s), protocol(s) and/or signal(s), such as a sequence of DTMF signals or using a voice-band modem.

To detect a provided dial-tone, the example service activator 550 of FIG. 5 includes a dial-tone detector 560. Using any number and/or type(s) of technique(s), circuit(s) and/or device(s), the example dial-tone detector 560 of FIG. 5 detects a provided dial-tone by detecting the presence of one or more pre-defined dial-tone signals and/or frequencies, such as the dial-tone signal created by the interference of 350 Hz and 440 Hz tones in North America.

To initiate a test call, the example service activator 550 of FIG. 5 includes a tester 565. When a dial-tone is detected, the example tester 565 of FIG. 5 initiates a test call to the telephone switch to verify the operation of the telephone service and to allow a subscriber to obtain the telephone number assigned to the newly activated telephone service. In the illustrated example of FIGS. 1 and 5, once the tester 565 initiates the test call, the switch 505 is controlled to connect the subscriber to the telephone switch via the initiated test call. When the test call is established, the telephone switch plays and/or provides a pre-recorded message that includes the telephone number assigned to the newly activated telephone service via the test call. By listening to the pre-recorded message, the user may obtain the assigned telephone number.

While an example voice module 415 is illustrated in FIG. 5, the voice module 415 may be implemented using any number and/or type(s) of other and/or additional processors, devices, components, circuits, modules, interfaces, etc. Further, the processors, devices, components, circuits, modules, elements, interfaces, etc. illustrated in FIG. 5 may be combined, re-arranged, eliminated and/or implemented in any of a variety of ways. Additionally, the example switch 505, the example off-hook detector 510, the example interactive voice response system 515, the example audio data 520, the example playback module 525, the example DTMF receiver 530, the example service activator 550, the example signal sender 555, the example dial-tone detector 560, the example tester 565, and/or, more generally, the example voice module 415 may be implemented as any combination of firmware, software, logic and/or hardware. Moreover, the example voice module 415 may include additional processors, devices, components, circuits, interfaces and/or modules than those illustrated in FIG. 5 and/or may include more than one of any or all of the illustrated processors, devices, components, circuits, interfaces and/or modules.

FIG. 6 illustrates an example manner of implementing the example web module 420 of FIG. 4. To detect the coupling of an IP-based communication device to the example web module 420 of FIG. 6 and/or a service module 140 that implements and/or includes the web module 420, the web module 420 includes a DHCP server 605. The example DHCP server 605 of FIG. 6 detects a coupled IP-based device by receiving a request from the device for an IP address. An example request is a DHCP request. Persons of ordinary skill in the art will readily recognize that the coupled device sends such a request when the device is first coupled to an IP-based network. Upon detection of a coupled IP-based device, the example DHCP server 605 of FIG. 6 provides an indication of the same to a subscription controller (e.g., the example controller 405 of FIG. 4).

To provide service information, advertisements and/or service selection prompts, and/or to receive user responses and/or selections, the example web module 425 of FIG. 6 includes a web server 610. The example web server 610 of FIG. 6 is able to provide and/or implement any number and/or type(s) of user interfaces, such as a web page created from web page data 620. In the illustrated example, the user interface(s) are displayed by the coupled IP-based device to provide information pertaining to available communication services, service advertisements, and/or service selection prompts. The user interfaces are provided by redirecting the viewing of a desired user interface (e.g., a desired web page) to the service information web page(s) provided by the web server 610 when the user first initiates a compatible application (e.g., starts a web browser application). The user interface(s) provided by the web server 610 may also be used to receive service selections and/or responses from a user of the communication device.

The example web page data 620 of FIG. 6 is stored using any number and/or type(s) of files, file formats or data structures (e.g., a text file) and/or is constructed in accordance with any number and/or type(s) of web page programming languages (e.g., hyper-text markup language (HTML), Java, Java script, etc.). The web page data 620 may be stored on any number and/or type(s) of storage devices and/or memories 622. In some examples, the web page data 620 may be modified, updated and/or changed by the subscription controller. An example user interface is described in connection with FIG. 8.

While an example web module 420 is illustrated in FIG. 6, the web module 420 may be implemented using any number and/or type(s) of other and/or additional processors, devices, components, circuits, modules, interfaces, etc. Further, the processors, devices, components, circuits, modules, elements, interfaces, etc. illustrated in FIG. 6 may be combined, re-arranged, eliminated and/or implemented in any of a variety of ways. Additionally, the example DHCP server 605, the example web server 610, the example web page data 620, and/or, more generally, the example web module 420 may be implemented as any combination of firmware, software, logic and/or hardware. Moreover, the example web module 420 may include additional processors, devices, components, circuits, interfaces and/or modules than those illustrated in FIG. 6 and/or may include more than one of any or all of the illustrated processors, devices, components, circuits, interfaces and/or modules.

FIG. 7 illustrates an example data structure that may be used to implement the subscription table 410 of FIG. 4. The example data structure of FIG. 7 contains a plurality of entries 705 for respective ones of a plurality of communication services. To identify the communication service, each of the service entries 705 of FIG. 7 includes a service type field 710. The example service type field 710 of FIG. 7 contains a number (e.g., a 2 digit number) that uniquely identifies the communication service.

To specify the status of the communication service at the network demarcation unit 135, 136, each of the service entries 705 of FIG. 7 includes a status field 715. The example status field 715 of FIG. 7 contains and/or represents a flag and/or value that indicates whether or not the communication service is activated and/or enabled. An example flag is a binary flag having a value of zero (0) to indicate that the service is inactive or a value of one (1) to indicate that the service is active.

To specify a code useable to activate the communication service, each of the service entries 705 of FIG. 7 includes a code field 720. The example code field 720 of FIG. 7 contains and/or represents any number and/or type(s) of codes (e.g., a sequence of digits) that may be used by a service module 140 to activate the communication service to the network demarcation unit 135, 136. For example, the code 720 may be used to represent a string of DTMF signals to be sent to a telephone switch to activate a telephone service.

While an example data structure has been illustrated in FIG. 7, any number and/or type(s) of additional and/or alternative data structures, tables, arrays, registers, variables, etc. may be used to store the data and/or information useful to track, record and/or determine which communication services are active. Moreover, the example data structure may include and/or store any number and/or type(s) of additional and/or alternative data and/or information associated with communication services, such as which communication services are available to, at and/or via a particular network demarcation unit 135, 136.

FIG. 8 illustrates an example user interface that may be implemented to prompt a user to select one or more communication services to activate. While a text-based user interface is illustrated in FIG. 8, persons of ordinary skill in the art will readily appreciate that user interfaces may be implemented using any combination(s) and/or arrangement(s) of text, menus, check boxes, text entry boxes, drop-down selectors, icons, etc. Persons of ordinary skill in the art will also readily recognize that the example user interface of FIG. 8 could, additionally or alternatively, be recorded and/or converted by machine to form one or more audio prompts of an interactive voice response system (e.g., the example interactive voice response system 515 of FIG. 5).

The example user interface of FIG. 8 contains a plurality of user interface elements 805 for respective ones of a plurality of potential and/or enabled user selections and/or responses. To describe the response, each of the example user interface elements 805 of FIG. 8 includes a description 810. The example description 810 of FIG. 8 provides a text based description of the selection.

To specify what the user is to do to make and/or indicate a particular selection, each of the example user interface elements 805 of FIG. 8 includes an action 815. Each example action 815 of FIG. 8 specifies and/or indicates to a user of the example user interface what they are to do to make a corresponding selection. For example, press the “1” key on their keyboard to order only phone services.

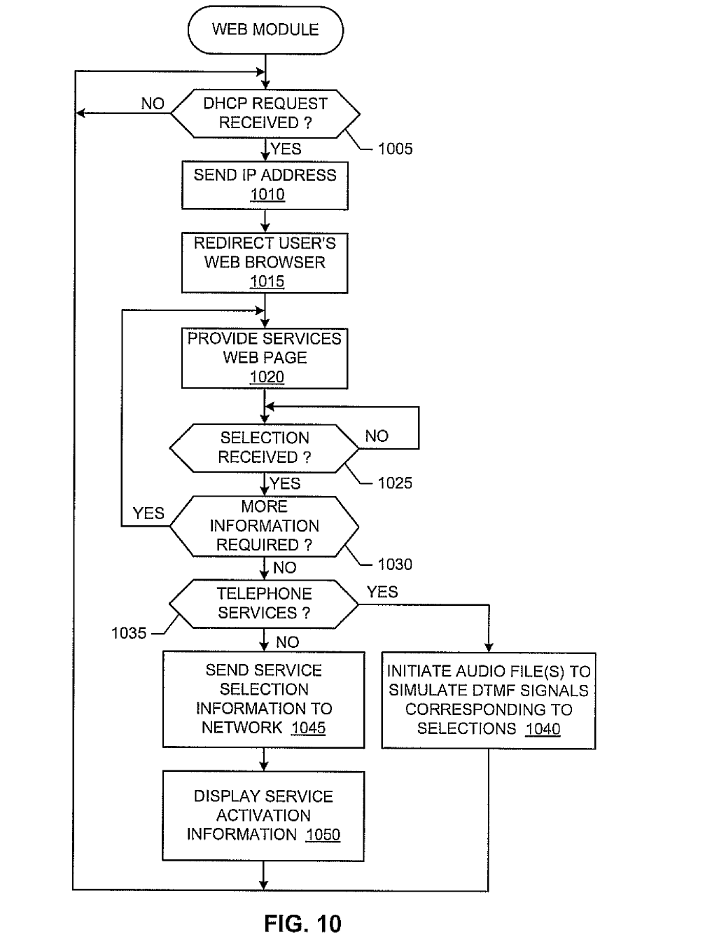

FIGS. 9A, 9B and 10 are flowcharts representative of example machine accessible instructions that may be executed to implement the example service modules 140, the example voice modules 415 and/or the example web modules 420 of FIGS. 1, 2, 3, 4, 5 and/or 6. FIG. 11 is a flowchart representative of example machine accessible instructions that may be executed to implement the example telephone switch 145 of FIG. 1. The example machine accessible instructions of FIGS. 9A, 9B, 10 and/or 11 may be executed by a processor, a controller and/or any other suitable processing device. For example, the example machine accessible instructions of FIGS. 9A, 9B, 10 and/or 11 may be embodied in coded instructions stored on a tangible medium such as a flash memory, a ROM, a hard drive and/or a RAM associated with a processor (e.g., the example processor 405 discussed above in connection with FIG. 4 and/or the example processor 1205 discussed below in connection with FIG. 12). Alternatively, some or all of the example flowcharts of FIGS. 9A, 9B, 10 and/or 11 may be implemented using any number and/or type(s) of ASIC(s), PLD(s), FPLD(s), discrete logic, hardware, firmware, etc. Also, some or all of the example flowcharts of FIGS. 9A, 9B, 10 and/or 11 may be implemented manually or as any combination(s) of the foregoing techniques, for example, any combination of firmware, software, discrete logic and/or hardware. Further, although the example machine accessible instructions of FIGS. 9A, 9B, 10 and 11 are described with reference to the flowcharts of FIGS. 9A, 9B, 10 and 11 persons of ordinary skill in the art will readily appreciate that many other methods of implementing the example service modules 140, the example voice modules 415 and the example web modules 420 and/or the example telephone switch 145 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 9A, 9B, 10 and/or 11 may be carried out sequentially and/or carried out in parallel by, for example, separate processing threads, processors, devices, discrete logic, circuits, etc.

The example machine readable instructions of FIG. 9A begin with a service module (e.g., the example service module 140 of FIGS. 1, 2 and/or 3) and/or, more particular, a voice module (e.g., the example voice module 415 of FIGS. 4 and/or 5) waiting to detect the coupling of an off-hook telephone to the service module (block 905). When an off-hook telephone is detected (block 905), the voice module (e.g., the example playback module 525 of FIG. 5) plays one or more pieces of communication service information and/or advertisements (block 910), and then provides a list of selection options and/or a service selection prompt (block 915). In some examples, the list of selections and/or prompts provided at block 915 may be customized and/or tailored by a subscription controller (e.g., the example controller 405 of FIG. 4) based upon communication services already activated and/or available to the subscriber (e.g., based on information stored in a subscription table, such as the example table 410 of FIG. 7).

When a DTMF signal is received (e.g., by the example DTMF receiver 530 of FIG. 5), the subscription controller and/or the voice module determines if emergency services were dialed (e.g., 911) (block 925). If emergency services were dialed (block 925), the voice module (e.g., the example switch 505) is controlled to connect the user to a telephone switch to complete the emergency services call (block 930). If at block 930, the emergency services call cannot be completed, the playback module 525 could, in some examples, play a pre-recorded message that indicates that the call can not be completed at this time and notifying the user to reach emergency services via some other method. When the emergency services call is completed (block 935), control returns to 905 to check if the telephone is off-hook.

Returning to block 925, if an emergency services call was not initiated, the voice module and/or the subscription controller determines if a user of the off-hook telephone is attempting to reach an operator and/or customer service representative (block 940). If the user is attempting to reach an operator or representative (block 940), the voice module (e.g., the example switch 505) is controlled to connect the user to a telephone switch to complete the call (block 945). Control then proceeds to block 960 of FIG. 9B.

If the user is not attempting to reach an operator or representative (block 940), the subscription controller determines if more information is required from the user (block 950). Example additional information includes an address, an account number, a subscriber name, a social security number, etc. Such additional information may be used to, for example, set up a new subscriber account for the service being activated, or to associate a service being activated with an existing account. If more information is required (block 950), control returns to block 915 to prompt the user for the additional information.

If no more information is required (block 950), the voice module (e.g. the example signal sender 555 of FIG. 5) sends to a telephone switch the service activation information (e.g., including the example code 720 for the service to be activated, and the identifier 265 for the corresponding network demarcation unit 135, 136 and/or service module 140) (block 955).

If a new telephone service is to be activated (block 960), the voice module (e.g., the example dial-tone detector 560 of FIG. 5) waits to detect a dial-tone signal (block 965). When a dial-tone signal is detected, the voice module (e.g., the example tester 565) initiates a test call (block 970). The voice module (e.g., the example switch 505) then connects the user to the telephone switch to listen to the test call (block 975). The service module and/or the voice module then enters a passive state waiting to receive an activation code (block 980). While the service module and/or the voice module is in the passive state, the newly activated service can be used as normal without interference by the service module and/or the voice module.

Returning to block 960, if a telephone service is not being activated (block 960), the service module and/or the voice module enters a passive state waiting to receive an activation code (block 980). When an activation code is entered by a user of an off-hook phone (block 980), control returns to block 910 to play a service advertisement and/or information (block 910) and to prompt the user to make a selection (block 915).

The example machine readable instructions of FIG. 10 begin with a service module (e.g., the example service module 140 of FIGS. 1, 2 and/or 3) and/or, more particularly, a web module (e.g., the example web module 420 of FIGS. 4 and/or 6) waiting to detect the coupling of an IP-based communication device to the service module (block 1005). When a DHCP request is received (block 1005), the web module (e.g., the example DHCP server 605 of FIG. 6) selects and/or provides an IP address to the requesting device (block 1110).

When a user of the device attempts to initiate a user interface (e.g., starts a web browser to view to a desired web page), the web module (e.g., the web server 610 of FIG. 6) redirects the web browser to a web page stored in the web module (e.g., a web page stored in the web page data 620) (block 1015). The web server then provides one or more service information, advertisement and/or user selection interfaces (e.g., web pages) to the user (block 1020). In some examples, the user interfaces provided at block 1020 may be customized and/or tailored by a subscription controller (e.g., the example controller 405 of FIG. 4) based upon communication services already activated and/or available to the subscriber (e.g., based on information stored in a subscription table, such as the example table 410).

When a user selection is received (block 1025), the web server determines if more information is required from the user (block 1030). Example additional information includes an address, an account number, a subscriber name, a social security number, etc. Such additional information may be used to, for example, set up a new subscriber account for the service being activated, or to associate the new service with an existing account. If more information is required (block 1030), control returns to block 1020 to prompt the user for the additional information.

If no more information is required (block 1030), the web module determines if a telephone service is to be activated (block 1035). If a telephone service is to be activated (block 1035), the example web module of FIG. 10 directs a voice module (e.g., the example playback module 525 of FIG. 5) to send DTMF signals to simulate and/or mimic user selections to the voice module (block 1040). Control then returns to block 1005 to wait for another DHCP request.

If a new telephone service is not to be activated (block 1035), the web server sends service activation information (e.g., including the example code 720 for the service to be activated and the identifier 265 for the network demarcation unit 135, 136 and/or service module 140) to a corresponding communication service server (e.g., the example servers 150, 170, 175) to activate the selected service(s) (block 1045). The web server then display information related to the service activation (e.g., when the service will be active, username, password, how to connect and/or configure equipment, etc.) for the user (block 1050). Control then returns to block 1005 to wait for another DHCP request.

The example machine readable instructions of FIG. 11 begin with a telephone switch (e.g., the example CLASS 5 telephone switch 145 of FIG. 1) waiting to receive a request from a service module (e.g., the example signal sender 555 of FIG. 5) to activate a telephone service (block 1105). When a request is received (block 1105), the telephone switch queries a telephone number database (e.g., the example database 185) to determine and/or select the next available telephone number (block 1110).

The telephone switch activates the selected telephone number by making the appropriate updates to the telephone number database and/or by notifying one or more operations support systems (e.g., the example operations support system 180) that telephone service to the subscriber is to be activated (block 1115). The telephone switch then enables dial-tone to the subscriber's telephone (block 1120) and waits to receive a test call from the service module (e.g., the example tester 565 of FIG. 5) (block 1125).

When the test call is received (block 1125), the telephone switch plays and/or provides one or more pre-recorded messages that include the telephone number assigned to the newly activated telephone service (block 1130). Control then returns to block 1105 to wait to receive another activation request.

FIG. 12 is a schematic diagram of an example processor platform 1200 that may be used and/or programmed to implement a portion of the example telephone switch 145, the example service module 140, the example subscription controller 405, the example voice module 415 and/or the example web module 420. For example, the processor platform 1200 can be implemented by one or more general purpose processors, processor cores, microcontrollers, etc.

The processor platform 1200 of the example of FIG. 12 includes at least one general purpose programmable processor 1205. The processor 1205 executes coded instructions 1210 and/or 1212 present in main memory of the processor 1205 (e.g., within a RAM 1215 and/or a ROM 1220). The processor 1205 may be any type of processing unit, such as a processor core, a processor and/or a microcontroller. The processor 1205 may execute, among other things, the example machine accessible instructions of FIGS. 9A, 9B, 10 and/or 11. The processor 1205 is in communication with the main memory (including a ROM 1220 and the RAM 1215) via a bus 1225. The RAM 1215 may be implemented by DRAM, SDRAM, and/or any other type of RAM device, and ROM may be implemented by flash memory and/or any other desired type of memory device. Access to the memory 1215 and 1220 maybe controlled by a memory controller (not shown). The RAM 1215 and/or the ROM 1220 may be used to store and/or implement, for example, the example subscription table 410, the example audio data 520, the example web page data 620 and/or the example telephone number database 185.

The processor platform 1200 also includes an interface circuit 1230. The interface circuit 1230 may be implemented by any type of interface standard, such as an external memory interface, serial port, general purpose input/output, etc. One or more input devices 1235 and one or more output devices 1240 are connected to the interface circuit 1230. The input devices 1235 and/or output devices 1240 may be used to, for example, the network interface 245 and/or interfaces to, for and/or within the example service module 140, the example voice module 415 and/or the example web module 420.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
detecting coupling of a subscriber communication device to a network demarcation unit; and
automatically providing service information from the network demarcation unit to a user of the subscriber communication device.

2. A method as defined in claim 1, further comprising determining if the subscriber communication device is associated with an existing communication service.

3. A method as defined in claim 1, further comprising:
receiving a selection from the user; and
automatically activating a communication service associated with the selection to the subscriber communication device.

4. (canceled)

5. A method as defined in claim 3, wherein the communication service is at least one of a telephone service, an Internet service, an access service, a video service, an audio service, or a television service.

6. A method as defined in claim 3, wherein receiving the selection from the user comprises receiving a dual tone multiple frequency signal associated with a key on a keypad of a telephone.

7. A method as defined in claim 3, wherein receiving the selection from the user comprises receiving a user interface selection.

8. A method as defined in claim 1, wherein detecting the coupling of the subscriber communication device comprises detecting an off-hook condition.

9. A method as defined in claim 1, wherein detecting the coupling of the subscriber communication device comprises receiving a dynamic host control protocol (DHCP) request.

10. A method as defined in claim 1, wherein providing the service information comprises providing an audible message that includes an indication of a keypad button to press to select a communication service.

11. A method as defined in claim 1, wherein providing the service information comprises providing a user interface that includes a selectable element to select a communication service.

12. (canceled)

13. (canceled)

14. (canceled)

15. (canceled)

16. A method as defined in claim 1, further comprising modifying the service information based upon a list of communication services available at the network demarcation point.

17. A method as defined in claim 1, wherein the service information includes at least one of an advertisement for a communication service, a communication service feature, a communication service availability, or a communication service cost.

18. (canceled)

19. (canceled)

20. (canceled)

21. (canceled)

22. (canceled)

23. A network demarcation unit comprising:
a service module to detect coupling of a communication device, and to provide service information to a user of the communication device; and
a connector to couple the communication device to the service module.

24. A network demarcation unit as defined in claim 23, wherein the service module is configured to:
receive a selection corresponding to a selected communication service from the user; and
activate the selected communication service.

25. A network demarcation unit as defined in claim 23, wherein the service module is configured to:
make a determination whether the communication device is associated with a communication service; and
to adjust the service information based on the determination.

26. A network demarcation unit as defined in claim 25, wherein the service module further comprises a subscription table that stores an indication whether the communication service is active at the communication device.

27. A network demarcation unit as defined in claim 23, wherein the communication device is a telephone, and wherein the service module comprises a voice module, the voice module comprising:
an off-hook detector to detect the coupling of the communication device by detecting an off-hook state of the telephone; and
an interactive voice response system to provide the service information by playing an audible message to the telephone and to receive a user selection from the telephone.

28. (canceled)

29. (canceled)

30. (canceled)

31. A network demarcation unit as defined in claim 23, wherein the communication device is an Internet Protocol (IP)-enabled device, and wherein the service module comprises a web module, the web module comprising:
a domain host control protocol (DHCP) server to detect the coupling of the communication device by receiving a DHCP request from the IP-enabled device; and
a web server to provide the service information by providing a user interface screen to the IP-enabled device and to receive a user selection from the IP enabled device.

32. A network demarcation unit as defined in claim 31, wherein the service module further comprises a voice module, and wherein the web module is configured to initiate a DTMF signal to provide the user selection to the voice module.

33. A network demarcation unit as defined in claim 23, wherein the network demarcation unit is a network interface demarcation (NID).

34. A network demarcation unit as defined in claim 23, wherein the network demarcation unit is an optical network terminal (ONT).

35. (canceled)

36. (canceled)

37. (canceled)

38. A network demarcation unit as defined in claim 23, wherein the communication device is at least one of a personal computer, a set-top box, a voice over Internet Protocol (VoIP) device, a telephone, a display device, a router or a residential gateway.

39. A network demarcation unit as defined in claim 23, wherein the communication service is at least one of a telephone service, an Internet service, an access service, a video service, an audio service, or a television service.

40. An article of manufacture storing machine accessible instructions which, when executed, cause a machine to:
detect coupling of a subscriber communication device to a network demarcation unit; and
automatically provide service information from the network demarcation unit to a user of the subscriber communication device.

41. An article of manufacture as defined in claim 40, wherein the machine accessible instructions, when executed, cause the machine to determine if the subscriber communication device is associated with an existing communication service.

42. An article of manufacture as defined in claim 40, wherein the machine accessible instructions, when executed, cause the machine to:
receive a selection from the user; and
automatically activate a communication service associated with the selection to the subscriber communication device.

43. (canceled)

44. (canceled)

45. (canceled)

46. An article of manufacture as defined in claim 40, wherein the machine accessible instructions, when executed, cause the machine to detect the coupling of the subscriber communication device by detecting at least one of an off-hook condition or a dynamic host control protocol (DHCP) request.

47. An article of manufacture as defined in claim 40, wherein the machine accessible instructions, when executed, cause the machine to provide the service information by providing an audible message that includes an indication of a keypad button to press to select a communication service.

48. An article of manufacture as defined in claim 40, wherein the machine by instructions, when executed, cause the machine to provide the service information by providing a user interface that includes a selectable element to select a communication service.

49. An article of manufacture as defined in claim 40, wherein the machine by instructions, when executed, cause the machine to modify the service information based upon a list of communication services available at the network demarcation point.

50. (canceled)
